(19) United States
(12) Patent Application Publication
(10) Pub. No.: US 2018/0116775 A1
(43) Pub. Date: May 3, 2018

(54) DENTAL CURING LIGHT

(71) Applicant: Garrison Dental Solutions, LLC, Spring Lake, MI (US)

(72) Inventor: Steven H. Peterson, Martin, MI (US)

(21) Appl. No.: 15/797,801

(22) Filed: Oct. 30, 2017

Related U.S. Application Data
(60) Provisional application No. 62/415,592, filed on Nov. 1, 2016.

(51) Int. Cl. A61C 13/15; A61C 1/00

(52) U.S. Cl. CPC A61C 19/004; A61C 1/0015

(57) ABSTRACT

A curing instrument with closed-loop control that is configured to manage the quantity of delivered energy to a curable material, including a composite restoration for a tooth. The closed-loop curing instrument is configured to analyze a signal indicative of the temperature at the curable material, and optionally the light reflecting from the curable material, and to adjust light output based on the analysis.

This application claims the benefit of U.S. Provisional Application DENTAL CURING LIGHT, application Ser. No. 62/415,592, filed Nov. 1, 2016, which is incorporated by reference herein in its entirety.

### TECHNICAL FIELD

The present disclosure relates to dental curing lights, and more particularly to controlled application of light from a dental curing light.

### BACKGROUND

Ten years ago the typical dental curing light used to cross-polymerize (i.e. harden) the resin used in modern composite fillings produced an optical power of typically 200 to 300 mW/cm². Since then the power levels have greatly increased with rapid advancements in LED technology. With the ensuing trend toward much higher power dental curing lights, intended to solve various issues of “under cure” and also to greatly reduce the time required to achieve full cure of a placed composite filling, several temperature related problems have become prevalent. First, with the increase in power output from the LEDs, the temperature of the treated tooth may be elevated to undesired levels, which can harm the vitality of the tooth pulp. In some cases, there is the possibility due to misalignment of the curing light the elevated temperatures can cause unintended direct exposure of tongue, cheek, or gingival tissues that in turn can cause painful and in some cases, severe, burns to those irradiated tissues.

### SUMMARY OF THE DESCRIPTION

An instrument for applying light energy to a light-curable target. The instrument includes a light source capable of outputting the light energy to the target, where the light source is controllable to effect, e.g. limit, the temperature of the target being illuminated. The instrument includes a temperature sensor for sensing the temperature at the target, and a feedback path operably coupled to the temperature sensor to provide a closed loop control of the light source. The instrument further includes a controller operably coupled to the temperature sensor and the light source. The controller is configured to control an operating characteristic of the light source to adjust the light energy being output from the light source based on the temperature sensed by the temperature sensor.

In one embodiment, the temperature sensor and related components form a closed-loop curing wand that manages the temperature of a tooth and composite restoration. The instrument according to one embodiment of the present disclosure controls the quantity of delivered energy based on the temperature of the tooth restoration and tooth and then by managing the power applied to the light source within the instrument to drive the output to desired level of energy that is to be directed at the targeted tooth surface.

In one embodiment, a curing instrument for curing a light-curable material includes at least one of a light source, drive circuitry, a controller, feedback circuitry, and a temperature sensor. The light source is configured to generate light energy to cure the light-curable material, and to provide an illumination beam of light energy to be directed to the light-curable material. The controller is configured to vary one or more operating characteristics of the light source based on the temperature detected by the temperature sensor at the light-curable material.

The temperature sensor is configured to generate a temperature sensor feedback signal based on the temperature detected at the restoration and tooth. Based on the temperature sensor feedback signal, the controller of the curing instrument directs the drive circuitry to vary output of light energy from the light source.

In one embodiment, a method of operating a curing light to cure a light-curable material may include at least one of the following steps: generating light energy from a light source, directing that light energy toward a target surface of the light-curable material, generating a temperature sensor feedback signal based on sensed infra-red light radiated from the target surface, and adjusting output of the light energy from the light source based on the temperature sensor feedback signal.

In another embodiment, the curing instrument also includes a light sensor for detecting reflected light from the target and light sensor feedback circuitry, which is operably coupled to the controller. The controller controls the light source based on the reflected light detected by the light sensor and the temperature sensed by the temperature sensor.

The method may also include determining the effective cure time of the cure process. For example, determining the effective cure time may include allocating a percentage of the actual cure time as the effective cure time for a given period of time to take into consideration a reduced output from the light source.

One or more embodiments described herein may achieve a real and effective construction that possibly avoids the potentially dangerous and potentially painful chance of overexposure to light energy, which may lead to thermal tissue damage. In this way, a more powerful curing instrument may be used while reducing the chances of over curing and possibly damaging the tooth or surrounding tissue. Additionally, one or more of the embodiments may avoid the all too common pragmatic approach of doubling or tripling exposures to assure a proper cure of the composite material. Where actual dosimetry of the tooth being treated is not known due to several variables that presently impact curing light dosimetry. The closed loop curing light approach may eliminate the wasted time and at the same time potentially eliminate possibly adverse effects associated high power curing lights.

These and other objects, advantages, and features of the disclosure will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a curing instrument according to one embodiment;

FIG. 2 is a schematic drawing of the components of the curing instrument of FIG. 1;

FIG. 3 illustrates a fragmented, partially sectioned view of a light application member of the curing instrument of FIG. 1;

FIG. 4 is a method of operating a curing instrument according to one embodiment;

FIG. 5 is a schematic drawing of another embodiment of a curing instrument;

FIG. 5A is a side view of another embodiment of a light application member;

FIG. 6 is a method of operating the curing instrument of FIG. 5 or 5A;

FIG. 7 is a perspective view of another embodiment of a curing instrument;

FIG. 7A is a side view of the light application member of the curing instrument of FIG. 7;

FIG. 8 is an enlarged perspective view of the end of the light application member of FIG. 7;

FIG. 9 is an enlarged side view of the end of the light application member of FIG. 7A; and

FIG. 10 is an enlarged end view of the optical fibers of the light application member of FIGS. 7-9.

### DETAILED DESCRIPTION

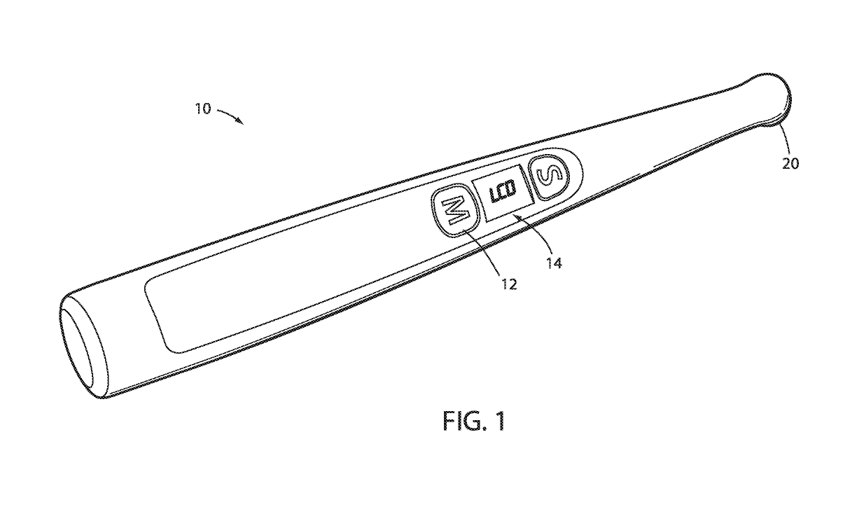

Referring to FIG. 1, the numeral 10 generally depicts a curing instrument for providing light to a composite material during a cure. Curing instrument 10 may be used to cure a light activated composite material, such as by polymerizing monomers into durable polymers. Curing instrument 10 may be a standalone device, such as a portable handheld wand having a battery power source and controls, or a component of a curing system having a base unit to which the curing instrument 10 is tethered and receives power therefrom and optionally control signals therefrom. A variety of fields may benefit from the curing instrument 10, including, for example, the dental and medical fields. For purposes of disclosure, curing instrument 10 is described as being a dental curing instrument for use in connection with curing a composite material having photo initiator, which absorbs light of a particular wavelength and causes polymerization of the monomers included in the composite material into polymers. It should be understood, however, that the present disclosure is not limited to the curing instrument being a dental curing instrument or limited to use with dental composite material—any curing application may benefit from the curing instrument, and any type of photo curable material may be used in conjunction with the curing instrument, including transparent, translucent and semi-opaque curable materials.

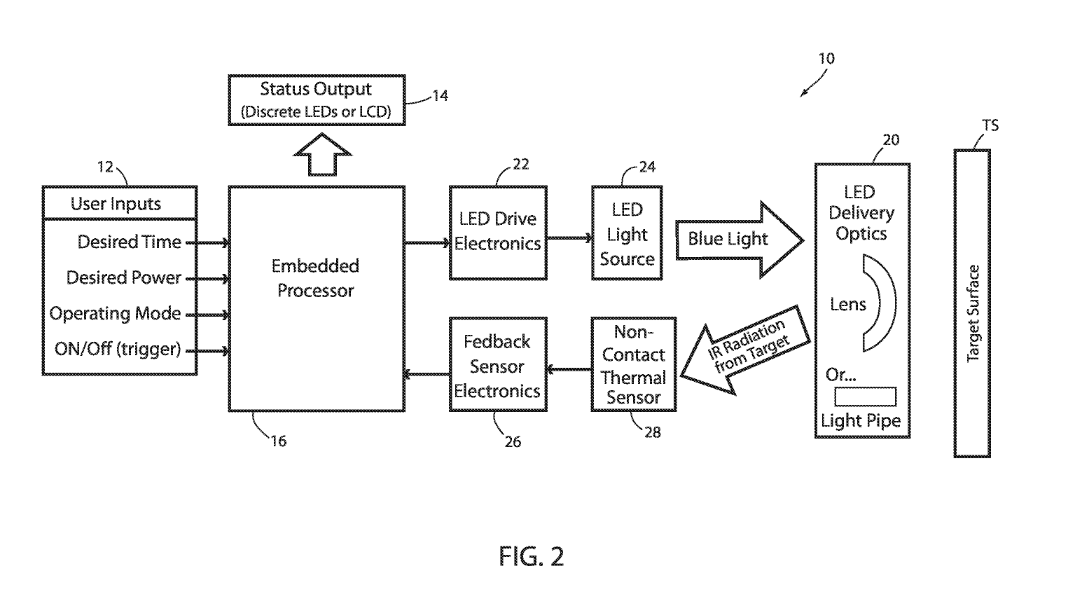

Referring again to FIGS. 1-2, curing instrument 10 includes a light application member 20 and optionally an operator interface 12 and an operator feedback element 14. As noted above, instrument 10 may be a standalone unit or be coupled to a control unit or the like, which may include the operator interface and/or operator feedback element. In use, an operator may activate the curing instrument 10 via the operator interface 12 (e.g. a start button “S” (FIG. 1) to initiate a curing operation of a composite material represented generally at TS, the target surface (FIG. 2). After activation, the curing instrument 10 may generate and emit light through a light passage of the application member 20. The operator may position the light application member 20 such that the light passage directs light toward the composite material in order to effect a cure thereof.

In the illustrated embodiment of FIG. 2, curing instrument 10 includes a controller 16 (e.g., an embedded controller, such as an embedded microprocessor-based controller), drive circuitry 22, a light source 24, temperature sensor feedback circuitry 26, and a temperature sensor 28. The drive circuitry 22 controls the supply of power to the light source 24 to generate light that is transmitted via the light application member 20 to the target surface. For instance, the drive circuitry 22 may include control drive circuitry that receives power from a power source (e.g., a battery of the curing instrument 10 or a hard wired power supply line), and provides that power as a power signal to the light source 24 according to one or more operating characteristics, such as a voltage magnitude, current magnitude, or duty cycle or a combination thereof. In response to receipt of power, the light source 24 generates light that can be directed to the target or targeted surface for the curing operation. The light source 24, in the illustrated embodiment, is primarily a deep blue and/or an Ultra-Violet (UV) light source, such as a UV light emitting diode (an LED that produces the shorter wave lengths of blue light), but may be configured differently. It should further be understood that the light source 24 in the illustrated embodiment—although primarily one type of light source (e.g., UV)—also may emit light of wavelengths different from those of the primary light type. For instance, the primary light output from a UV LED is UV light, but the UV LED may also emit light in the visible spectrum or infrared spectrum, or both, along with the UV light.

The controller 16 of the curing instrument 10 in one embodiment may include an algorithmic computational solution element or controller module, such as a shared computational module incorporated into the controller 16, forming an embedded control system that controls light output and potentially additional instrument functionality. Optionally, this module may be separate from the controller 16 and incorporated into another hardware module that along with the controller 16 forms at least part of a control system for the curing instrument 10.

Control over generation of light from the light source 24, as mentioned above, is conducted through the drive circuitry 22, which is also referred to as an LED power control element but is not so limited. In the illustrated embodiment, the controller 16 may be coupled to and control operation of the drive circuitry 22. The controlled level of the operating characteristic or operating characteristics of the drive circuitry 22 is governed at least in part by the controller 16 to control the power signal provided to the light source and to control the light output thereof. For example, the controller 16 may provide a control signal or control information to the drive circuitry 22 to provide power to the light source 24 according to a target operating characteristic. As will be more fully described below, the control signal or control information provided from the controller 16 may be dynamic such that, during a curing operation, the control signal or control information may vary to effect a change in the target operating characteristic.

The drive circuitry 22, in one embodiment, may utilize feedback circuitry to achieve the target operating characteristic. For instance, the drive circuitry 22 may include a current sensor that senses current supplied to the light source 24, and based on the sensed current, the drive circuitry 22 may adjust operation to vary the supply current to more closely align with a target supply current. Additionally or alternatively, the controller 16 may direct operation of the drive circuitry 22 based on sensed information related to operation of the drive circuitry 22 in supplying power to the light source 24, including, for example, adjusting one or more target operating characteristics, such as duty cycle, based on a deviation between a target current and a sensed operating current.

The drive circuitry 22 may include circuitry that turns ON/OFF the light source 24, and that manages the power output during use. The drive circuitry 22 may receive input from the controller 16 to control the output of the light source 24. The drive circuitry 22 may include the capability of managing output power of the light source 24 with more resolution that merely turning ON or OFF or selecting one of two or three preset power levels. For instance, the drive circuit 22 may control one or more operating characteristics, including, for example, controlling duty cycle of power applied to the light source 24 to control the amount of output power. As another example, the drive circuitry 22 may control the amplitude or the rail voltage, or both, of power applied to the light source 24 to affect and control output power. In some circumstances, the drive circuitry 22 may be controlled by the controller 10 to achieve “ramping” exposure profiles, or exposure profiles or operating profiles that change over the course of the curing operation rather than a profile configured to supply a substantially constant amount of light energy to a target surface. For instance, the curing instrument 10 may vary an output level of the light source 24 to effect, e.g. limit, the temperature of the target surface—with the output level of the light source 24 shifted or varied over the course of the curing operation while the controller 16 controls supply of power to the light source 24 according to the temperature of the target surface, as more fully described below.

In the illustrated embodiment, controller 16 of the curing instrument 10 controls the drive circuitry 22 based on feedback obtained from temperature sensor 28. Such feedback-based control may be implemented in conjunction with any of the control methodologies described herein, including, for example, controlling one or more operating characteristics, e.g. of the light source, based on feedback from the light source 24. Temperature sensor 28 may be a conventional non-contact temperature sensor that detects infra-red radiation (IR) and is configured to sense the temperature at the target based on the infra-red radiation emitted from the target.

In the illustrated embodiment, the IR radiation is directed along a feedback path, such as an optical feedback path, configured to channel the radiation to feedback circuitry 26. Based on the temperature feedback from the temperature sensor 28, the feedback circuitry 26 will generate a temperature sensor feedback signal indicative of the sensed temperature and provide the temperature feedback signal to the controller 16. By analyzing the temperature feedback signal, controller 16 may dynamically vary the control signal or control instructions provided to the drive circuitry 22, thereby dynamically adjusting one or more operating characteristics of the drive circuitry 22 and, hence, of the output from the light source 24 based on the temperature (e.g. change in temperature as described below) at the target.

Additionally, or alternatively, the controller 16 may determine one or more timing aspects related to delivery of light, and dynamically calculate or adjust a duration for applying light to the targeted surface. For instance, based on the temperature feedback signal, the controller 16 may determine whether the temperature sensed at the target surface exceeds threshold value or a temperature limit or exceeds a change-in temperature limit, and instruct or command the drive circuitry 22 to discontinue delivering or reduce the amount of light energy that is directed toward the target in response to the temperature or change-in temperature reaching or exceeding a threshold value or limit.

In one embodiment of the curing instrument 10, temperature sensor 28 is positioned relative to the light application member 20 such that the input to the temperature sensor 28 is disposed to collect radiation emitted from the target. The temperature sensor 28 according one embodiment may include an optical fiber with the input being formed at a distal end of the optical fiber. The input may be surface treated, such as by polishing, so that the input is configured to collect the radiation, as described herein.

In one embodiment, the optical fiber is configured such that a distal end corresponding to the input is constructed as a side-firing tip. With this construction, the optical fiber may collect radiation at an angle different from a central axis of the optical fiber, including, for example, radiation directed substantially perpendicular with respect to a central axis of the optical fiber. The distal end of the optical fiber in a SIDE FIRE configuration may be treated such that a surface of the distal end is angled (e.g., about 42 deg.) relative to the central axis of the optical fiber. It should be understood that the feedback circuit 26 may be arranged to collect radiation at different angles, including, for example, between 20 and 160 deg. relative to the central axis of the optical fiber.

In the illustrated embodiment, as noted, temperature sensor 28 is configured to sense the radiation emitted from the target. This temperature sensor arrangement may achieve an optical connection between the feedback circuitry 26 and the “target” surface via the temperature sensor 28 and the light application member 20, described more fully below. Such an optical path may be accomplished by an isolated, dedicated optical fiber as noted, or by other blended optical arrangements, so as to enable the signal received by the temperature sensor to largely, or at least in part, include the radiation emitted from the targeted surface. As will be more fully described, the feedback may also include information related to light reflected off the target.

The temperature feedback signal, generated by the feedback circuitry 26, may then be processed by the controller 16 to eliminate or greatly reduce known and derived sensory error sources, as well as to compensate for factors impacting the feedback signal and to thereby compute in real-time the temperature (or change in temperature) at the actual targeted surface. As explained herein, the computation of actual temperature (or change in temperature) at the targeted surface may form a basis of operation according to one or more methods or modes of operation.

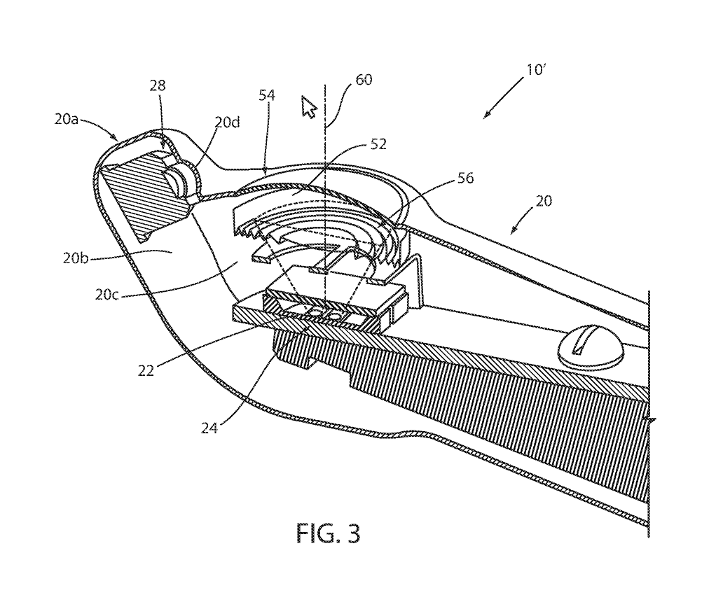

In another embodiment of the curing light 10′, referring to the partially exposed and partial sectional view of the light application member 20 depicted in the illustrated embodiment of FIG. 3, the light application member 20 may include drive circuitry 22, light source 24, and one or more temperature sensors 28. In the illustrated embodiment, only one sensor is shown. Sensor 28 is mounted to the light application member 20 offset from the optical path of the light emitted from light source 24. The thermal sensor electronics may be housed with the respective sensor 28 or may be located on a separate circuit board located in the housing of light application member 20 closer to or at the controller 16, with the sensor 28 in communication with the thermal sensor electronics or controller 16 via wiring (not shown) that extends through the housing of light application member 20.

As best seen in FIG. 3, the housing that forms light application member 20 includes an extended portion 20a with a cavity 20b that is open to or in communication with cavity 20c, which holds the light source and lenses described below. Extended portion 20a houses and supports temperature sensor 28 and includes an opening 20d that forms a window through which sensor 28 senses the heat at the target, namely the tooth restoration.

The light application number 20 supports light source 24 on one end of a support arm 40 that extend through the housing of the light application member and supports the controller 16 on the opposed end nearer the user inputs (shown in FIG. 1). Further, light application number 20 may also include a lens 52 configured to direct light energy from the light source 24 to the targeted surface and an optional reflector ring 56 configured to direct light from light source 24 toward the lens 52. Optionally, the light application member 20 may include a custom lens such as a Fresnel lens, with elements for focusing the UV light as well as elements to collect longer wave IR light. The light application member 20 may also include a bezel or outer retainer ring 54 constructed to maintain the position of lens 52, light source 24, and reflector ring 56 at the application end of the light application member 20. It should be understood that the construction of the lens of the light application member 20, as well as the physical arrangement or use of one or more components including the bezel 54 and the reflector ring 56, may be varied from application to application.

In the illustrated embodiment, the light source 24 and input of the temperature sensor 28 are offset from each other so that sensor is not coaxial with the light source illumination cone. Temperature sensor 28 is disposed to capture the radiation emitted from the target, and such that its optical path is offset from a central axis 60 of the optical path of the illuminating beam of the light source 24. For additional details of the components and operation of the components of curing light 10′ reference is made to curing light 10.

The curing instrument 10 or 10′ according to one embodiment may be a high power (>2000 mW/cm²) LED based dental curing wand. More specifically, the curing instrument 10 may be capable of varying the output level of the light source 24, such as a high power LED, to cure a dental composite material according to manufacturer specifications for the material. The curing instrument 10 or 10′ may form part of an optical delivery system that according to one embodiment may be capable of sustaining at least 2000 mW/cm² at a target distance of 2 cm to 5 cm from the a tip of the light application number 20, and may be configured such that a profile of irradiance across the beam generated by the tip is substantially homogeneous within 20% of the average power across the tip. It should be understood that the present disclosure is not limited to these features and that alternative instrument or wand configurations are contemplated, as noted above.

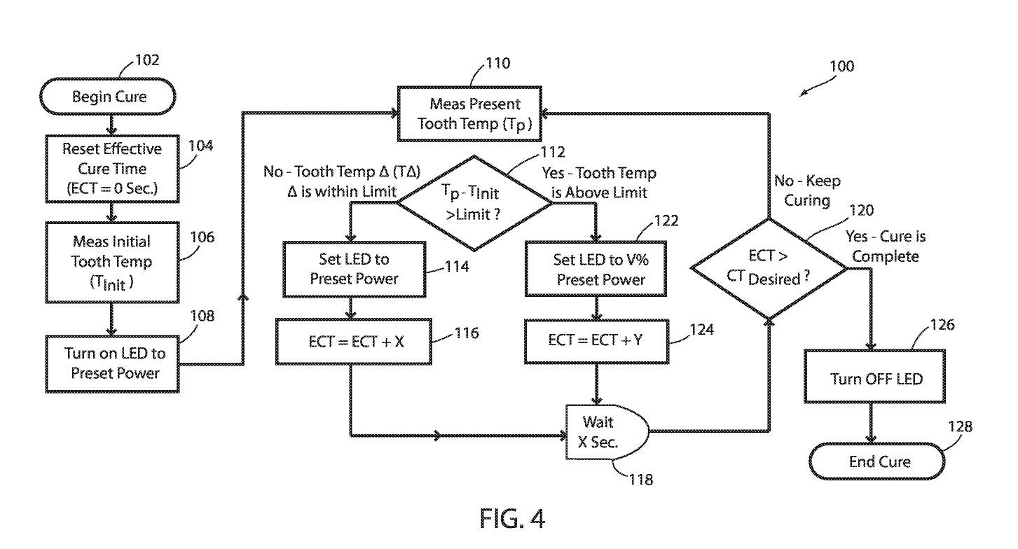

Referring to FIG. 4, in one embodiment, the controller 16 is configured to control the output of light from the light source 24 based on the temperature feedback signal according to a first operational mode in which the real-time temperature is measured. When the change-in temperature of the target exceeds a maximum change-in temperature limit, the controller 16 of the curing instrument 10 or 10′ lowers the power on the light source and, further, optionally extends the cure time to achieve a complete cure. It should be understood that the controller 16 may instead base its control of the light source on the absolute temperature measured at the target instead of the change in temperature, but additional compensation may have to be made for variations in emissivity of the target and tolerances in the components, for example from aging or inherent variations in the light source.

As will be more fully described below, curing instrument 10 or 10′ according to one embodiment may additionally implement closed loop control of light output based on a sensed parameter or characteristic of light reflecting from the target surface, which itself may be indicative of the light energy at or reaching the target.

In addition, the instrument may also internally sense internal light output from the light source 24 of the curing instrument 10 or 10′. Internally sensing the light output, alone without determining the amount of light externally applied to the target, may allow the curing instrument 10 or 10′ to compensate for aging or variations in the light source or lamp, but generally does not account for variables that may exist between the source generation of the curing instrument 10 or 10′ and the intended final target destination of the light. Operator variations from use to use may be compensated for by sensing a parameter indicative of the light actually reaching the target.

Referring again to FIG. 4, a method of operation of the curing instrument or curing system according to one embodiment is generally designated 100. The method 100 may be implemented as a control module in the controller 16 using feedback based on one or more parameters or characteristics, namely radiation emitted from the target surface, and optionally one or more sense characteristics of the curing instrument 10 or 10′. In the illustrated embodiment, the method 100 includes initiating a cure operation 102 followed by setting the effective cure time (ECT) to 0 seconds (104). The controller 16 then measures the initial tooth temperature (Tᵢₙᵢₜ) (106). After the initial tooth temperature (Tᵢₙᵢₜ) is measured (108), controller 16 instructs the drive circuitry 22 to power the light source 24 according to an initial setting, such as a preselected source power level, thereby starting application of light to the targeted surface (108). Controller 16 then measures the present tooth temperature (Tp) (110). After measuring the tooth present temperature (110), controller 16 compares the measured present temperature (Tp) to the initial tooth temperature (Tᵢₙᵢₜ) and determines whether the change in temperature (T_{Δ}) is greater than a threshold level, such as a tooth temperature limit (112). If controller 16 determines that the change in temperature (T_{Δ}) is less than the tooth temperature limit, then controller 16 powers the light source, e.g. the LED light source, to its preset power (114). For example, the preset power may be in a range of about 1000 mW/cm² to 3000 mW/cm² or greater than about 2000 mW/cm².

The curing instrument according to one embodiment is configured to cure a restorative compound by controlling light output during the cure cycle to achieve a target output, possibly specific to the curable material or restorative compound being used. For instance, the operator may utilize an operator interface, such as operator interface 12 (FIGS. 1 and 2), to select a target cure setting for a curing operation that is prescribed by a manufacturer of the curable material being used. In this way, the amount of light energy applied during a curing operation may be selectively chosen based the material being used rather than “over-curing” the curable material by a factor of two or three to eliminate a potential under-cure due to distance, angle, or other external variation factors. If curing intensity levels are considered low (e.g., 200 to 300 mW/cm²), intentional over-curing a curable material by a factor of two or three to eliminate a potential under-cure due to distance, angle, or other external variation factors is often not considered to be an issue. However, with use of curable materials that prescribe higher cure energies, and therefore a higher energy curing instrument (e.g., an instrument that produces at least 1000 mW/cm² and possibly up to 3000 mW/cm² or more), intentional over-curing can result in application of energy that is an order of magnitude greater than that of direct sunlight (e.g., 100 mW/cm²). The curing instrument in the illustrated embodiment of FIG. 2 utilizes feedback based on the temperature of the target and optionally based on light reflected from the target to control the delivery of light energy, thereby substantially avoiding significant over-curing and intentional over-curing procedures that generate light energies two to three times the prescribed amount.

In the illustrated embodiment, the controller may be configured to track and manage the effective cure time (ECT) during the curing process to assure proper curing. Further, the controller may be configured to adjust the effect cure time (ECT) to compensate for the reduced output from the light source, as will be described below. In the illustrated embodiment, controller 16 increases the effect cure time (ECT) stored in memory by a preselected period of time X, for example, by a tenth of a second, by adding a value (X) corresponding to the period of time to the ECT stored in the memory of controller 16 (116), which is initially set at zero when the curing process is initiated. As the curing process progresses, the ECT is increased by controller 16 either based on the actual time period or by a reduced time period as noted below. Further, controller 16 includes a timer, which is referenced by controller 16 to hold a wait to take further action until the period of time X has passed (118), for example 0.1 seconds (120).

After the period of time X (e.g. 0.1 seconds) has passed, controller 16 then compares the ECT value now stored in memory to the desired cured time (CT) (120). If the stored effective cure time (ECT) is less than the desired cure time (CT), the controller 16 again measures the current tooth temperature (Tp) (110). This is repeated until, either the stored effective cure time (ECT) is greater than the desired cure time (CT), in which case controller 16 will turn off the power to the light source, e.g. the LED light source (126), and the curing process is terminated at 128.

However, if at step 112, controller 16 determines that the change in tooth temperature (T_{Δ}) is greater than the temperature limit, then controller 16 reduces the power to the light source (122) and, further, adds to the effective cure time (ECT) stored in memory a value Y that represents some value, less than preselected time period X, for example a percentage of X (124). In the illustrated embodiment, controller 16 greatly reduces the power to the light source to avoid overheating. The reduction is dependent on a number of variables, including the preset power, the size of the target (e.g. tooth) is, etc. So, for example, for a higher preset power, for example, in a range of 2000 mW/cm²-3000 mW/cm² or greater, the reduction may be in a range of about 40% to 5% reduction, whereas for preset power in a range of 1000-1500 mW/cm², the reduction may be in a range of about 60% to 30%. Overall the reduction may fall in a range of about 60% to 5%, optionally in a range of about 50% to 10%, optionally in a range of about 40% to 15%, and optionally about 20%. Similarly, the value Y may be in a range 60% to 5%, of X, optionally in a range of about 50% to 10% of X, optionally in a range of about 40% to 15% of X, and optionally about 20% of X.

After controller 16 has increased the stored value for the effective cure time (ECT), controller 16 will again wait for a period of X seconds (118) (e.g. 0.1 seconds), and thereafter compare the stored value of the ECT to the desired cure time (CT) (120).

If the stored effective cure time is less than the desired cure time, then controller 16 will again measure the present or current tooth temperature at 110 and repeat steps 114, 116 or 122 and 124 described above. If at 120, as noted above, controller 16 determines that the effective cure time (ECT) is greater than the desired cure time (CT), then controller 16 will no longer supply power to the light source (126) and terminate the curing process at 128.

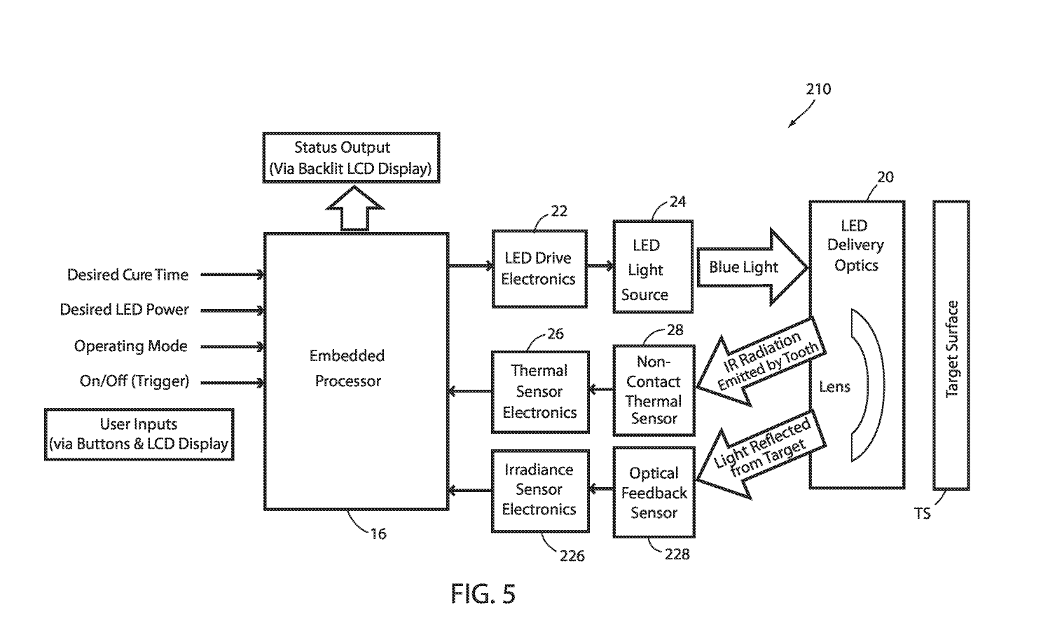

Referring to FIG. 5, the numeral 210 represents another embodiment of a curing instrument in which the curing instrument also incorporates a second feedback sensor in the form of a light sensor to measure the reflected light off the target to control operation of light source 24 based on how much energy actually reaches the target surface TS. The curing instrument 210 may further be configured to utilize feedback to adjust the light output of light source 24 in order to substantially reduce or eliminate the effects of external error sources, which can often be the principal factor or factors in how much optical energy makes it to the targeted surface.

In addition to sensing the temperature at the target, the curing instrument 210 according to one embodiment, may sense one or more characteristics indicative of the amount of light actually making it to the targeted surface, which includes the composite material, such as a compound restoration that is targeted for curing. Based on the one or more parameters, the curing instrument 210 may “throttle” the light source output, either up or down, to achieve a target irradiance power (mW/cm²) and total energy (Joules/cm²) delivered to the targeted surface.

In other words, the curing instrument 210 may be configured to control an amount of total optical energy applied (Joules) to the intended target, and in so doing, the rate of power applied to the target (mW/cm²) during the exposure time may be controlled to avoid exceeding a target level of optical energy. Control over optical energy output based on optical feedback can be achieved in a variety ways. For purposes of disclosure, the present disclosure includes several embodiments that implement such control-based delivery of light to a curable material. However, it should be understood that the present disclosure is not limited to the specific constructions and embodiments described herein, and that essentially any controlled curing instrument is contemplated. For additional details not provided herein, reference is made to U.S. patent application Ser. No. 14/857,273 (P-111A), which is incorporated by reference herein in its entirety.

As best seen in FIGS. 5 and 5A, the curing instrument 210 includes controller 16, drive circuitry 22, light source 24, and temperature sensor 28, as described above, and an optical feedback sensor 228 and optical feedback circuitry 226. As described above, drive circuitry 22 controls the supply of power to light source 24 to generate light that may be transmitted via the light application member 220 to the target. In addition, the illustrated embodiment, curing instrument 210 includes a light application member 220 with two extended portion 220a (only one shown, the second portion is on the opposed side of the end of the light application members to that they can straddle the tooth). Each extended portion 220a includes a cavity 220b that is open to or in communication with cavity 220c, which holds the light source and lenses. Each extended portion 220a houses and supports a temperature sensor 28 and includes an opening 220d that forms a window through which each temperature sensor 28 senses the heat at the target, namely the tooth restoration. For further details of light source 24, drive circuitry 22, and temperature sensor 28 reference is made to the descriptions above.

In the illustrated embodiment, controller 16 of the curing instrument 210 controls the drive circuitry 22 based on feedback obtained from temperature sensor 28, as described above, as well as optical feedback sensor 228. Such optical feedback-based control may be implemented in conjunction with any of the control methodologies described herein, including, for example, controlling one or more operating characteristics of the light source to achieve a desired optical output.

In the illustrated embodiment of FIGS. 5 and 5A, the curing instrument 210 includes an optical feedback sensor 228 configured to sense light reflecting from the target surface, to which light from the light source 24 is directed, and an optical feedback path configured to channel light or a characteristic of the light sensed by sensor 228 to optical feedback circuitry 226. Based on optical feedback from the optical feedback sensor 228, the optical feedback circuitry 226 generates an optical sensor feedback signal indicative of the sensed light and provides the optical sensor feedback signal to the controller 16. By analyzing the optical sensor feedback signal in conjunction with the temperature feedback signal, the controller 16 is operable to dynamically vary the control signal or control instructions provided to drive circuitry 22, thereby adjusting one or more operating characteristics of the optical drive circuitry 22 and output from the light source 24 based on sensed light reflected from and measured temperature (e.g. temperature change) at the target surface.

Additionally, or alternatively, the controller 16 may determine one or more timing aspects related to delivery of light based on the optical sensor feedback signal 228, and dynamically calculate a duration for applying light to the targeted surface. For instance, based on the optical sensor feedback signal, the controller 16 may determine an amount of light energy delivered to the target surface or a given amount of time, and instruct or command the optical drive circuitry 22 to discontinue delivering light energy in response to the amount of delivered light energy reaching or exceeding a threshold.

Referring again to FIG. 5, curing instrument 210 includes a light sensor element in the optical feedback circuitry 226 that receives light or a characteristic thereof via the optical feedback path of the optical feedback sensor 228. The light sensor element of the curing instrument 210 may be located so as to be systematically connected to the controller 16 so that output of light from the light source 24 may be controlled based on sensed light, as well as the temperature at the target surface TS. The light sensor element of the optical feedback circuitry 226 may be a photodiode that is sensitized to one or more wavelengths of light, such as the spectrum of light corresponding to UV radiation. It should be understood that any type of light sensor element may be incorporated the optical feedback circuit 226, and that the light sensor element may be sensitive to more than one spectrum of light. The optical sensor feedback signal received by the controller 16 may be an analog signal from the optical feedback circuitry 226. The controller 16 may be configured to convert the analog signal to digital information for further processing as described herein. Additionally, or alternatively, the optical sensor feedback signal provided by the optical feedback circuitry 226 may be a digital signal representative of information or data relating to reflected light sensed by the light sensor element of the optical feedback circuitry 226.

In one embodiment of the curing instrument 210, the optical feedback sensor 228 may serve to preferentially collect some portion of the light reflected off from the surface of the intended target area of the area (e.g., the composite material) being treated, and may also serve to deliver this light to the light sensor element of the optical feedback circuitry 226 for quantification. The optical feedback sensor 228 may be positioned relative to the light application member 20 such that a light input of the optical feedback sensor 228 is disposed to collect light reflected from the target surface. The optical feedback sensor 228 according one embodiment may be an optical fiber 228a with the light input being formed at a distal end of the optical fiber. The light input may be surface treated, such as by polishing, so that the light input is configured to collect reflected light, as described herein. In one embodiment, the optical fiber 228a may be configured such that a distal end corresponding to the light input is constructed as a side-firing tip. With this construction, the optical fiber may collect light at an angle different from a central axis of the optical fiber, including, for example, light directed substantially perpendicular with respect to a central axis of the optical fiber. The distal end of the optical fiber in a SIDE FIRE configuration may be treated such that a surface of the distal end is angled (e.g., about 42 deg.) relative to the central axis of the optical fiber. It should be understood that the optical feedback circuit 228 may be arranged to collect light at different angles, including, for example, between 20 and 160 degrees relative to the central axis of the optical fiber.

In alternate embodiment, optical cable 228a may comprise a fiber optic bundle, for example, a bundle of seven fibers, each for example, with a 50 micron diameter. In this manner, the fiber optic bundle may be bent so that its input end is generally perpendicular to the optical path (which eliminates the need for a SIDE FIRE tip) for receiving the incoming IR light from the target, e.g. the tooth.

In the illustrated embodiment, as noted, the light sensor 228 is not to be configured for the purpose of sensing LED output from the light source 24, but rather to sense the light reflected back from the targeted surface. This light sensor arrangement may achieve an optical connection between the optical feedback circuitry 226 and the target via the optical path element or light sensor 228. Such an optical path may be accomplished, as noted, by an isolated, dedicated optical fiber, or by other blended optical arrangements, so as to enable the optical signal received by the light sensor of the optical feedback circuitry to largely, or at least in part, include the light reflected off of the targeted surface. The optical sensor feedback signal, generated by the optical feedback circuitry 226 and based on the light provided via the optical path of the light sensor 228, may then be processed by the controller 16 to eliminate or greatly reduce known and derived sensory error sources as well as to compensate for optical factors impacting the optical sensor feedback signal and to thereby compute in real-time a “delivered” energy level (in mW/cm²) at the actual targeted surface. As explained herein, the computation of actual irradiance level at the targeted surface may form a basis of operation according to one or more methods or modes of operation.

In one embodiment, the controller 210 may be configured to control the output of light from the light source 24 based on the optical sensor feedback signal according to a first operational mode in which the real-time “delivered” energy value may be digitally integrated during the time of the exposure to compute the total Joules of energy delivered to the targeted surface up to that point. As the delivered energy reaches the desired level, the controller 16 of the curing instrument 210 may automatically turn off the light source 24 and notify the operator that the exposure has been completed.

In a second operational mode, the curing instrument 210 may use the computed irradiance at the targeted surface (e.g., the tooth or composite material surface) to create an “error value” in real time that represents the over or under exposure at the targeted surface for that moment in time with respect to a target irradiance level initially set or expected by the operator of the curing instrument 210. This error signal may be used as a basis for throttling the light source 24 up or down to substantially ensure that the target surface is receiving a desired amount of mW/cm² of irradiance at any given moment of the curing process or operation. This second mode may also help to ensure that overly intense irradiation levels are avoided instead of merely shortening the total exposure time.

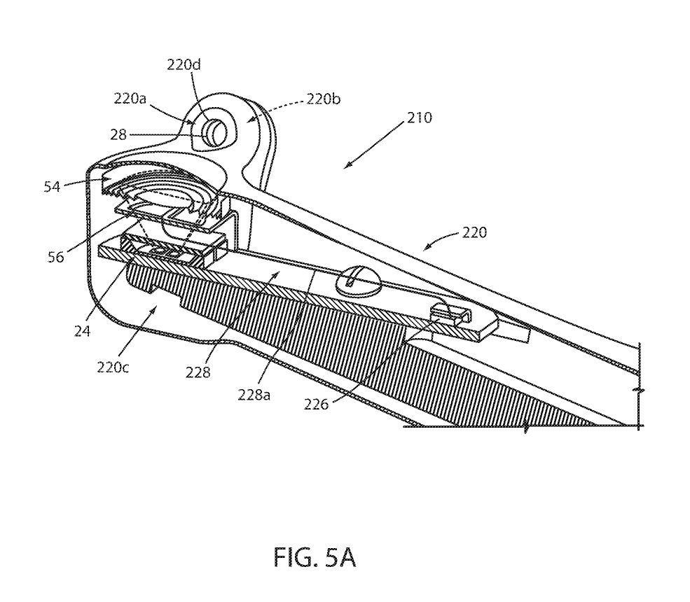

A method of operation of curing instrument or curing system 210 according to one embodiment is depicted in the illustrated embodiment of FIG. 6, and generally designated 300. The method 300 may be implemented as a control module in the controller 16 of instrument 210 using feedback based on one or more parameters or characteristics, as noted, such as reflected light from the target surface, temperature change at the target surface, and optionally one or more sense characteristics of the curing instrument 210, itself. In the illustrated embodiment, the method 300 includes initiating a cure operation (302) and initializing an accumulator or integrator that tracks an amount of light energy delivered to a target surface (304). Controller 16 is also configured to measure the initial tooth temperature (Tint) and to instruct the optical drive circuitry 22 to power the light source 24 according to an initial setting (306), such as a preselected source power level, thereby starting application of light to the targeted surface (308).

For example, initiation of the curing operation may start in response to activation of a user input (e.g., a button) of the operator input.

The method 300 may include computing irradiance at the targeted surface (314) and the total amount of energy delivered to the target surface which represents the over or under exposure at the targeted surface for that moment in time with respect to a target irradiance level initially set or expected by the operator. Further, this is then to be used as a basis for adjusting the optical drive circuitry 22 so as to either increase or reduce output from the light source 24 by a calculated value and thereby assure that energy losses between the light source 24 and the target surface are compensated and that the target surface is receiving the target number of mW/cm² of irradiance at any given moment of the curing process (316, 318, 320, 322). As an example, at step 318, the method 300 may determine whether the amount of irradiance delivered (Iₜₒₒₜₕ) is greater or less than a calculated amount of expected irradiance, which may correspond to the desired or expected amount of irradiance (I_{cmd}) for a given time. If the calculated irradiance at any given measurement cycle is greater, or less than, the desired amount of radiance (I_{cmd}), then controller 16 will adjust the power to the light source 22 (320) accordingly to better maintain the desired irradiance. For example, this adjustment may be slight, and range from about 0.4% to 10.0% adjustment in power per measurement cycle of irradiance. The irradiance measurements and subsequent adjustments are executed in repetitive fashion during the duration of the cure as often as, for example, 500 times per second.

After the power is adjusted (e.g., increased or decreased), controller 16 will again determine the irradiance (314) and the total amount of energy delivered to the target surface (316), which will be repeated until controller 16 determines at 312 that a predetermined time period X, such as 0.1 seconds, has passed. If on the other hand, the irradiance level at the tooth is determined to be less than the desired irradiance (I_{cmd}), then controller 16 (at 322) will slightly increase the power to the light source 24 (322).

After the predetermined time period X has passed, controller 16 will then measure the present or current tooth temperature (Tp) (324). If controller 16 determines that the tooth temperature change (T_{Δ}), i.e. the change from initial tooth temperature (Tinit) to present tooth temperature (Tp), is below the tooth temperature limit (326), then controller 16 will set the irradiance to the initial specified power, namely Irr_{cmd}=Irr_{spec} (328). Further, controller 16 will determine whether the total energy delivered (J_{delivered}) exceeds the desired energy (J_{desired}) (330).

On the other hand, if at step 326, controller 16 determines that the tooth temperature rise (T_{Δ}) is above the tooth temperature limit, controller 16 will set the irradiance to a fraction, e.g. ⅕ of the initial specified power (Irr_{cmd}=Irr_{spec}/5), and then determine whether the delivered energy (J_{delivered}) exceeds the desired energy (J_{desired}). If the delivered energy is less than the desired energy, controller 16 will keep curing and reset the thermal timer to the preselected time period (310), e.g. 0.1 seconds, and the process will return to checking whether the preselected time period has passed and to computing the irradiance and the total energy delivered at the targeted surface (312, 314, 316). If the amount of energy delivered exceeds the desired energy, controller 16 instead will no longer power the light source 24 (332) and end the cure process (334).

Further, the method 300 may determine whether the amount of energy delivered (J_{delivered}) is greater or less than a calculated amount of expected energy, which may correspond to the desired or expected amount of energy (J_{desired}) for a given time period, or correspond to a fraction of the total prescribed amount of energy for the curing operation for the period of time since the curing operation was initiated. The method 300 may facilitate substantial avoidance of overly intense irradiation levels instead of shortening the total exposure time.

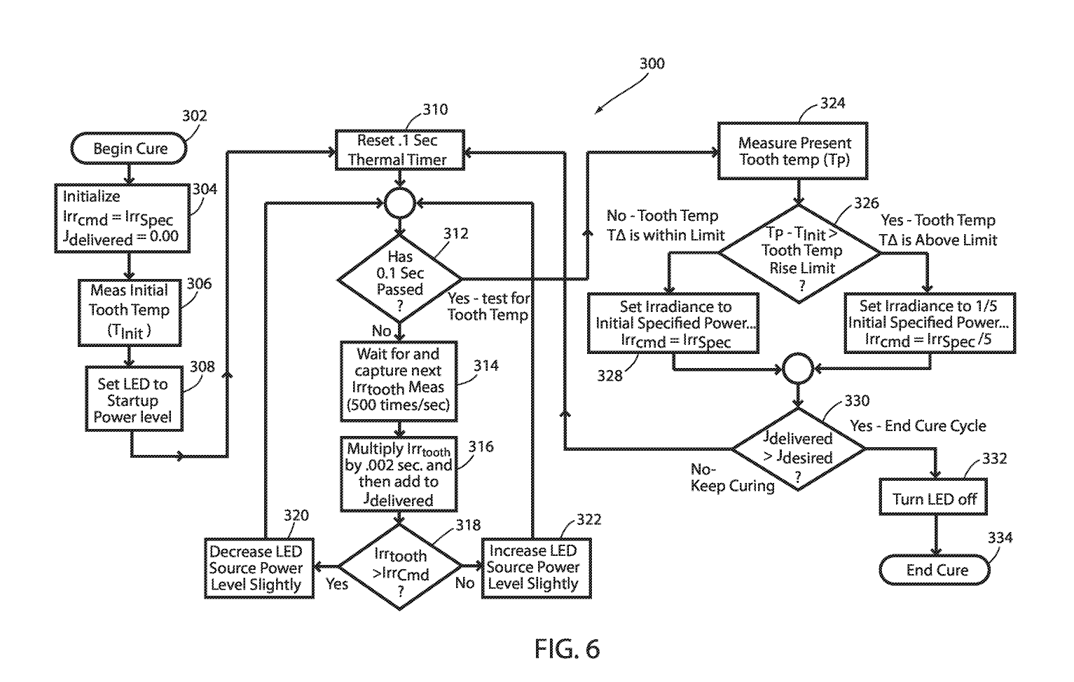

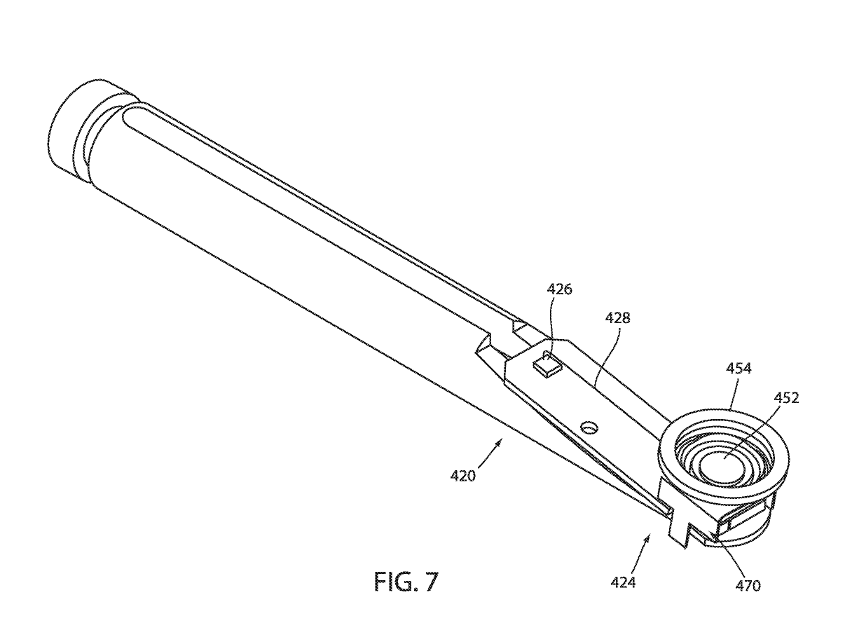

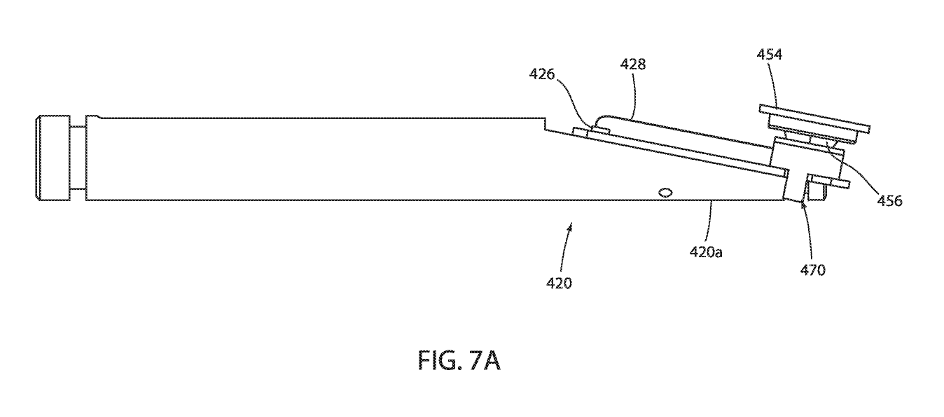

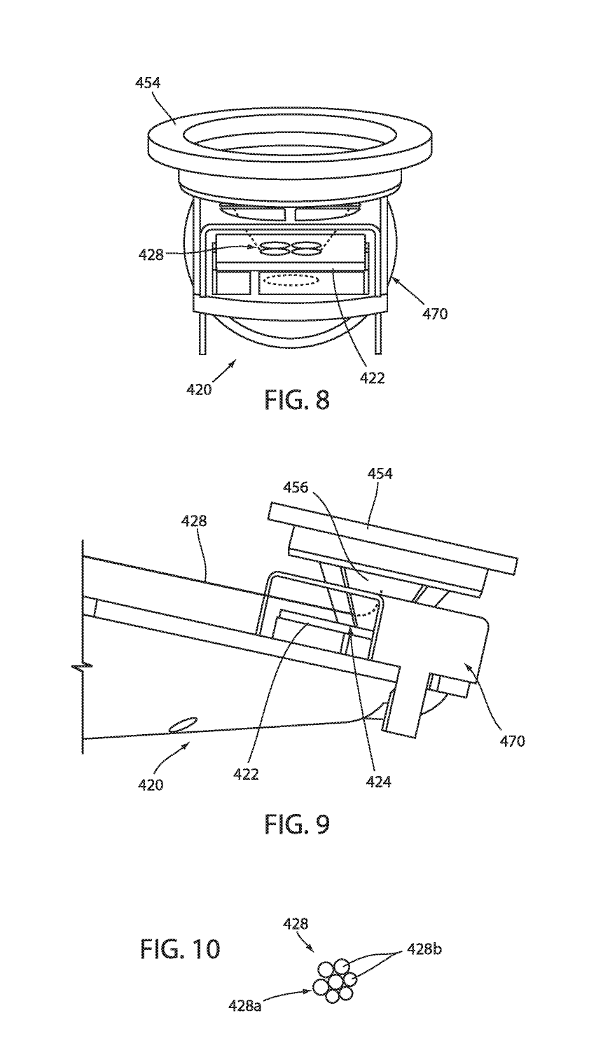

Referring to FIG. 7, the numeral 420 designates another embodiment of a light application member. As best seen in FIGS. 7-9, light application member 420, similar to light application member 20, includes a light source 424, with drive circuitry 422, feedback circuitry 426 (FIG. 7), and one or more sensors 428. Sensor 428 may comprise a light sensor or a temperature sensor, or both. In the illustrated embodiment, sensor 428 includes a fiber optic bundle 428a, for example, a bundle of seven fibers 428b, each, for example, with a 50 micron diameter. In this manner, as described above, the fiber optic bundle may be bent so that its input end is generally perpendicular to the optical path (which eliminates the need for a SIDE FIRE tip) for receiving the incoming IR light from the target, e.g. the tooth. Similar to the previous embodiments, fiber optic bundle 428a is coupled on one end to feedback circuitry 426 and, at its opposed end, is positioned to have a “direct view” of the target optionally via an optical lens noted below.

In one embodiment, the fiber bundle may feed two different sensors, which are coupled with a dual band detector (such as a Si-1132) to form two sensors, e.g. a temperature sensor and a light sensor, so that both signals can be read and processed as generally described above. Alternately, the optical bundle can be spilt to feed two different sensors—one optimized for the blue/UV light and one optimized for the IR temp related signal.

Also similar to the previous embodiments, light application member 420 includes a bezel 454 that mounts about lens 456 and further includes a housing 470 that mounts the lens, light source 424 (and associated circuitry), and the bezel 454 to the end 420a of light application member 420.

In the illustrated embodiment, housing 470 comprises an inverted U-shaped frame that is configured to straddle and mount, for example, with a press fit to end 420a of light application member to thereby hold lens 456 over and in alignment with the light source formed on circuit board 422.

In the illustrated embodiment, the light source 424 and the input of the sensor 428 (or sensors) may be disposed such that an optical path of the sensor is within an optical path of the light source. In this way, the optical path of the input to sensor 428 may be considered a sensing optical path, and the optical path of the light source 424 may be considered an illuminating optical path. Alignment of the illuminating and sensing optical paths, such as coaxial alignment of these optical paths, may assure that the sensed zone of the target surface does not substantially migrate within the illuminated zone of the target surface as a function of distance from the source. For further discussion regarding the coaxial nature of the sensing optical path and the sensing optical path reference is made to the above description.

As noted, curing instrument 10, 10′, 210, and/or 410 may be a high power (>2000 mW/cm²) LED based dental curing wand. More specifically, the curing instruments may be capable of varying an optical output level of the light source, such as a high power LED, to cure a dental composite material according to manufacturer specifications for the material. The curing instruments may form part of an optical delivery system that according to one embodiment may be capable of sustaining at least 2000 mW/cm² at a target distance of 2 cm to 5 cm from the a tip of the light application member, and may be configured such that a profile of irradiance across the beam generated by the tip is substantially homogeneous within 20% of the average power across the tip. It should be understood that the present disclosure is not limited to these features and that alternative instrument or wand configurations are contemplated.

Curing instruments 10, 10′, 210, and/or 410 with all or some of the features described above may achieve closed-loop control of light output to a target surface. Alternatively or additionally as another mode of operation, the curing instruments 10, 210, and/or 410 may achieve open loop control of light output to the target surface. With the ability to measure the target temperature and sense optical output as feedback, and to use the feedback to compute, track, and compensate for actual optical energy being delivered to and/or the actual temperature change (or actual temperature) at the surface of the tooth, the curing instruments described herein may significantly enhance clinical performance and provide enhanced safety in curing dental restorative compounds. In so doing, the curing instruments may help to substantially eliminate a great number of variables impacting exposure level at the targeted surface and the subsequent post-procedural problems that sometimes occur with either under exposure (e.g., insufficient cure of compound) or over exposure, which may potentially cause damage to live tissue from over-heating.

Curing instruments 10, 10′, 210, or 410 may be configured with a quality optical design by implementing controlled manufacturing processes to produce an instrument that demonstrates a substantially homogeneous field of light across the tip of the instrument that is consistent from use to use, even if the light source, itself, is inclined to exhibit a slight, but continuous, decay in its output level over its “life”. It is noted that LEDs often times do not “burn out” in a catastrophic fashion as do their incandescent counterparts, but rather tend to slowly decrease in intensity over their life. LED lifetime can be expressed as the number of hours before they reach either 50% or 70% of original intensity, depending on the LED “life” standard that is being used. The controller of curing instrument 10, 210, or 410 may adjust output intensity of the light source based on the optical sensor feedback signal to counteract degradation of the light source over its lifetime. The controller may also conduct diagnostic analysis based on the optical sensor feedback signal, such as determining whether the light source is operating according to one or more operational parameters sufficient for conducting a cure operation. In this way, the controller of the curing instrument 10, 10′, 210, or 410 may conduct built in diagnostics (BIT). Additionally, or alternatively, the BIT conducted by the controller may include analysis of battery or power source stability or sufficiency or both, and determining whether contamination is present on a lens or tip through which light is emitted from the light application member.

After light from the light source reaches the tip of the instrument, many additional variables can, and sometimes do, impact the effective delivery of those photons onto the intended surface. In cases of hand held use by an operator, probably the most significant of these variables is the operator's accuracy (or variance) with respect to placement of the curing instrument during the time of the exposure or the curing operation. Depending on various factors, such as the optical design of the tip of the light applicator member, its effective numerical aperture, and the geometry of tip diameter vs. intended working distance, a variation of better than 5 to 1 can be experienced in light attenuation during hand held curing operations. As an example, clinically relevant irradiance has been demonstrated to drop off significantly in some cases due to a change in target distance from 2 mm to 8 mm. Furthermore, additional variation as high as 2 to 1 may occur from angular variation between the axis of the tip surface and the normal of the target surface being treated. The curing instrument according to one embodiment may be configured to substantially account for this variability by utilizing closed loop feedback based on sensed light reflected from the target surface, thereby enabling control over the irradiance.

It should be understood that the curing instrument according to one embodiment implements closed loop control of light output based on the temperature of the target as well as a sensed parameter or characteristic of light reflecting from the target surface, which itself may be indicative of the light energy at or reaching the target. In addition, instrument 10 or 10′ or 210 or 410 may internally sense internal light output from the light source of the curing instrument. Internally sensing the light output, alone without determining the amount of light externally applied to the target, may allow the curing instrument to compensate for aging or variations in the light source or lamp, but generally does not account for variables that may exist between the source generation of the curing instrument 10 or 10′ or 210 and the intended final target destination of the light. Operator variations from use to use may be compensated for by sensing a parameter indicative of the light actually reaching the target.

The acceptance and utilization of composites for dental restoration has grown tremendously over the last couple of decades, including use of composites on anterior teeth. Use of anterior tooth composites has given rise to composites of different shades to match the same color of the natural tooth to which the composite is being applied. The different shade offerings, in many cases, call for different amounts of target light energy to complete a cure. Darker shades often cause much more internal attenuation of light as it is scattered about and transmitted through the composite material. This often results in increased target energy to cure the darker shades. As an example, one manufacturer may provide a composite that needs 6 Joules/cm² (e.g. for lighter shades), but may require 24 Joules/cm² (e.g. for darker shades). This is a four-to-one variation in prescribed energy delivery, and as such represents an additional 4 fold increase in the total range of appropriate energy levels that may now be prescribed to achieve a target cure for various composite materials.

Curing instrument 10, 10′ 210, or 410 according to one embodiment may be configured to cure a restorative compound by controlling light output during the cure cycle to achieve a target output, possibly specific to the curable material or restorative compound being used. For instance, the operator may utilize the operator interface (e.g. interface 12) to select a target cure setting for a curing operation that is prescribed by a manufacturer of the curable material being used. In this way, the amount of light energy applied during a curing operation may be selectively chosen based the material being used rather than “over-curing” the curable material by a factor of two or three to eliminate a potential under-cure due to distance, angle, or other external variation factors. If curing intensity levels are considered low (e.g., 200 to 300 mW/cm²), intentional over-curing a curable material by a factor of two or three to eliminate a potential under-cure due to distance, angle, or other external variation factors is often not considered to be an issue. However, with use of curable materials that prescribe higher cure energies, and therefore a higher energy curing instrument (e.g., an instrument that produces at least 1200 mW/cm² and possibly up to 3000 mW/cm² or more), intentional over-curing can result in application of energy that is an order of magnitude greater than that of direct sunlight (e.g., 100 mW/cm²). The curing instrument in any of the illustrated embodiments, as described, may utilize optical feedback based on light reflected from the target surface to control the delivery of light energy, thereby substantially avoiding significant over-curing and intentional over-curing procedures that generate light energies two to three times the prescribed amount.

Directional terms, such as “vertical,” “horizontal,” “top,” “bottom,” “upper,” “lower,” “inner,” “inwardly,” “outer” and “outwardly,” are used to assist in describing the disclosure based on the orientation of the embodiments shown in the illustrations. The use of directional terms should not be interpreted to limit the present disclosure to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements or configurations, illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A curing instrument for curing a target, the target including a restorative material that is curable in response to application of light energy, the curing instrument comprising:
a light source capable of outputting the light energy to cure the restorative material, the light source being controllable to vary the light energy being output;
a temperature sensor operable to sense temperature at the target and configured to generate a temperature sensor feedback signal based on the temperature sensed at the target; and
a controller operably coupled to the temperature sensor and the light source, the controller configured to control an operating characteristic of the light source based on the temperature sensor feedback signal.

2. The curing instrument according to claim 1, further comprising an optical path operably coupled to the temperature sensor, the optical feedback path being configured to channel IR light form the target to the temperature sensor.

3. The curing instrument according to claim 2, wherein the light source generates an illumination beam, the optical feedback path being coaxially aligned with the illumination beam.

4. The curing instrument according to claim 1, wherein the controller is configured to determine the change in temperature at the target between initiating a curing cycle and at periodic intervals during the curing cycle.

5. The curing instrument according to claim 4, wherein said controller adjusts the output of the light energy of the light source when said controller determines that the change in temperature at the target exceeds a desired temperature.

6. The curing instrument according to claim 1, wherein said operating characteristic includes the effective cure time.

7. The curing instrument according to claim 1, wherein said operating characteristic further includes the output of said light source, and said controller further configured to determine the effective cure time based the output of said light source.

8. The curing instrument according to claim 7, wherein said controller is further configured to adjust the effective cure time when said controller varies the output of said light source.

9. The curing instrument according to claim 7, wherein said controller is configured to compare the effective cure time to a desired cure time and terminate the curing process when the effective cure time is equal to or exceeds the desired cure time.

10. The curing instrument according to claim 1, further comprising a light sensor operably coupled to said controller, said light sensor generating an optical sensor feedback signal, and said controller controls said light source based on the optical sensor feedback signal in addition to the temperature sensor feedback signal.

11. The curing instrument of claim 10, wherein the controller is programmed to compute the actual total energy delivered to the target.

12. A method of operating a curing instrument to conduct a curing operation of a light-curable material, said method comprising:
generating light energy from a light source;
directing the light energy toward a target associated with the light-curable material;
generating a temperature feedback signal based on the temperature at the target; and
varying a characteristic of the light energy from the light source based on the temperature feedback signal.

13. The method of claim 12 further comprising determining the change in temperature at the target and comparing the change in temperature to a change in temperature limit.

14. The method of claim 12 further comprising supplying a power signal to the light source in order to generate the light energy, and wherein said varying a characteristic includes adjusting output of the light energy from the light source.

15. The method of claim 12 wherein the characteristic of the light energy includes at least one of a magnitude of current, a magnitude of voltage, a duty cycle of the power supply signal.

16. The method of claim 12 further comprising generating an optical feedback signal based on sensed light reflected from the target.

17. The method according to claim 16, further comprising iteratively calculating a total amount of light energy delivered to the target surface based on the optical sensor feedback signal, and determining whether the calculated amount of light energy is equal to or exceeds a prescribed amount of light energy for the light-curable material.
